(19) United States
(12) Patent Application Publication
(10) Pub. No.: US 2008/0186405 A1
(43) Pub. Date: Aug. 7, 2008

(54) METHOD FOR GENERATING GAMMA VOLTAGE AND DEVICE USING THE SAME

(75) Inventor: Kuo-Jung Li, Tainan County (TW)

Correspondence Address: J C PATENTS, INC., 4 VENTURE, SUITE 250, IRVINE, CA, 92618, US

(73) Assignee: HIMAX DISPLAY, INC., Tainan County (TW)

(21) Appl. No.: 11/671,807

(22) Filed: Feb. 6, 2007

(51) Int. Cl. H04N 5/202; G09G 3/36

(52) U.S. Cl. 348/674; 345/89; 348/E05.074

(57) ABSTRACT

The present invention discloses a method for generating gamma voltage and device using the same. The method for generating gamma voltage to a driver of a panel comprising following steps of: providing a plurality of first gamma reference values; providing a central value; generating a plurality of second gamma reference values, wherein each of the plurality of first gamma reference values and each of the plurality of second gamma reference values are symmetrical with respect to the central value; and generating a plurality of first gamma reference voltages and a plurality of second gamma reference voltages in accordance with the plurality of first gamma reference values and the plurality of second gamma reference values.

### BACKGROUND OF THE INVENTION

1. Field of Invention

The present invention relates to a method for generating a voltage and a device using the same, and more particularly to a method for generating a gamma voltage and a device using the same.

2. Description of Related Art

FIG. 1 illustrates a diagram of the transmittance versus the driving voltage for a liquid crystal display. As shown in FIG. 1, there exists a nonlinear correlation between voltage applied to the liquid crystals and transmittance of light. For this reason, it is necessary to create a gamma curve corresponding to characteristics of the liquid crystal display to improve display quality thereof.

FIG. 2 illustrates a gamma curve diagram for a liquid crystal display of a normally white type. The gamma curve 201 formed with several gamma voltages V21˜V30 with respect to the transmittance of light. As a conventional technology, it is necessary to individually set all the different gamma values RV21˜RV30 (not shown) corresponding to those gamma voltages V21˜V30 first. Afterward a digital-to-analog converter (DAC) transforms the gamma values into the corresponding gamma voltages and thereby provides to form the gamma curve 201.

FIG. 3 illustrates a gamma curve diagram for a liquid crystal display of a normally black type. Referring to FIG. 2 for generating all the different gamma voltages V31˜V40, it is necessary to individually set all the different gamma values RV31˜RV40 (not shown) first. However, the non-symmetrical driving voltages corresponding to a non-symmetrical gamma curve will induce the flicker phenomena of image and make the poor image quality. With reference to FIG. 2 and FIG. 3, it is appeared that the gamma curve is symmetric at two sides of a center voltage.

### SUMMARY OF THE INVENTION

Accordingly, one object of the present invention is to provide a method for generating a gamma voltage to a driver of a panel. The present invention, make use of the characteristics of the symmetrical gamma curve to adjust the gamma voltages.

Another object of the present invention is to provide a gamma voltage generator for a panel, wherein a well adjustment way to the gamma voltage can be acquired.

In order to achieve the aforesaid object, the present invention provides a method for generating a gamma voltage to a driver of a panel. The method comprises the following steps of: providing a plurality of first gamma reference values; providing a central value; generating a plurality of second gamma reference values, wherein each of the first gamma reference values and each of the second gamma reference values are symmetrical to the central value; and generating a plurality of first gamma reference voltages and a plurality of second gamma reference voltages in accordance with the first gamma reference values and the second gamma reference values.

The present invention further provides a gamma voltage generator for a panel. The gamma voltage generator comprises a symmetry unit for receiving a plurality of first gamma reference values and a central value to generate a plurality of second gamma reference values, wherein each of the first gamma reference values and each of the second gamma reference values are symmetrical to the central value; and a digital-to-analog converter (DAC) electrically coupled to the symmetry unit for outputting a plurality of first gamma reference voltages and a plurality of second gamma reference voltages in accordance with the first gamma reference values and the second gamma reference values.

In order to make the aforementioned and other features and advantages of the present invention comprehensible, preferred embodiments accompanied with figures are described in detail below.

### BRIEF DESCRIPTION OF THE DRAWINGS

FIG. 1 illustrates a diagram of the transmittance versus the driving voltage for a liquid crystal display.

FIG. 2 illustrates a gamma curve diagram for a liquid crystal display of a normally white type.

FIG. 3 illustrates a gamma curve diagram for a liquid crystal display of a normally black type.

FIG. 4 illustrates a block diagram of a gamma voltage generator for a panel according to an embodiment of the present invention.

FIG. 5 illustrates a gamma value setting table according to an embodiment of the present invention.

FIG. 6 illustrates a flow of a method for generating a gamma voltage according to an embodiment of the present invention.

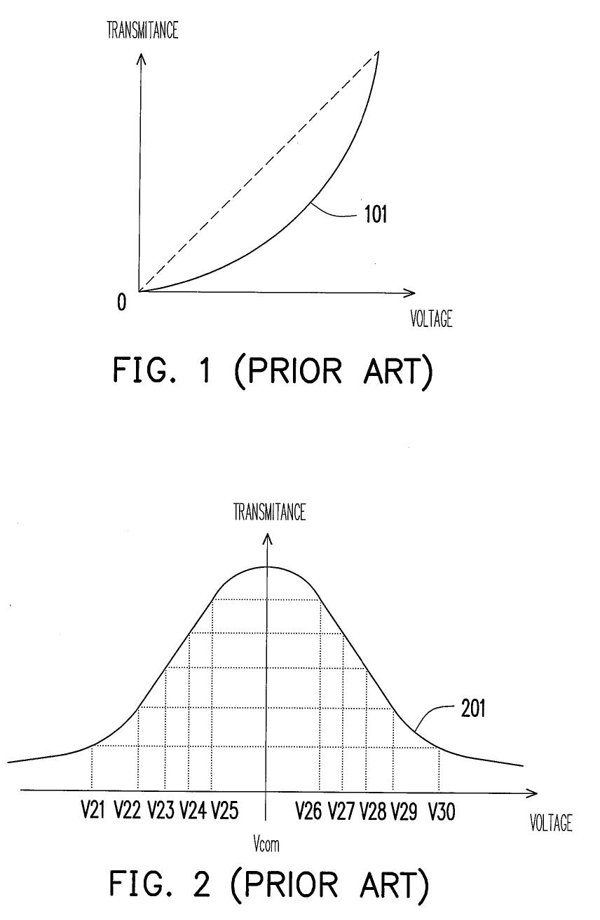

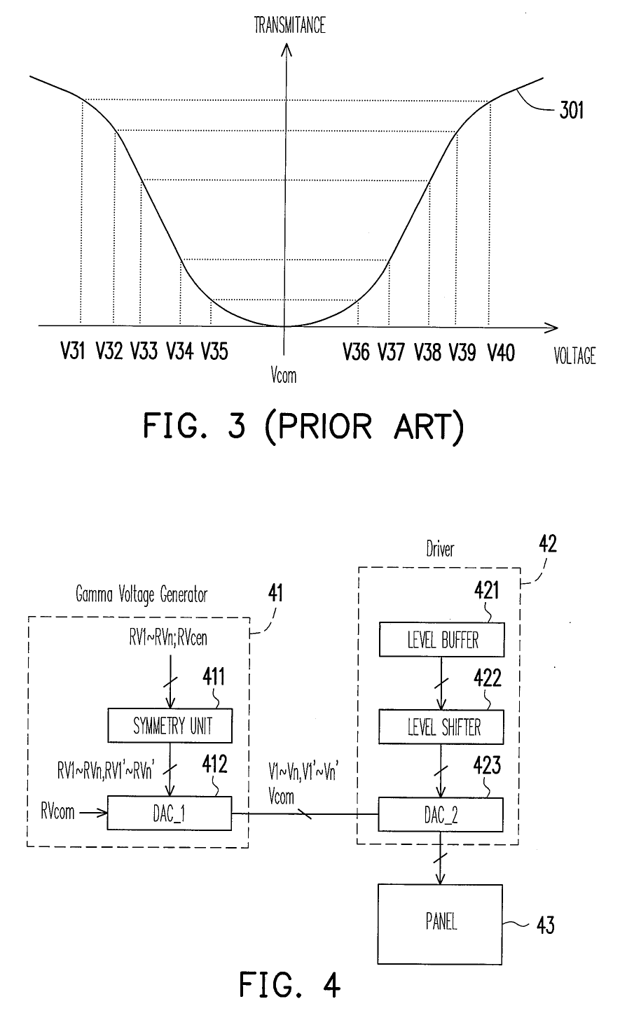

### DESCRIPTION OF EMBODIMENTS

The present invention will now be described with reference to the accompanying drawings, in which exemplary embodiments of the invention are shown. The invention may, however, be embodied in many different forms and should not be construed as being limited to the embodiments set forth herein. Furthermore, the embodiments are provided so that this disclosure will be thorough and complete, and will fully convey the concept of the invention to those skilled in the art. Liquid crystal display is taken as an example in the embodiments to illustrate the operating principle of the present invention. However, the embodiments of the present invention are not limited to the liquid crystal display, and any display with liquid crystal is also suitable to be used in the present invention, such as an LCOS and an OLED.

FIG. 4 illustrates a block diagram of a gamma voltage generator and a driver with a panel according to an embodiment of the present invention. The gamma voltage generator 41 comprises a symmetry unit 411 and a digital-to-analog converter (DAC)412. The driver 42 comprises a line buffer 421, a level shifter 422, and a digital-to-analog converter (DAC) 423. The symmetry unit 411 receives first gamma reference values RV1˜RVn and a central value RVcen to generate second gamma reference values RV1′˜RVn′, in which each of the first gamma reference values RV1˜RVn and each of the second gamma reference values RV1′˜RVn′ are symmetrical with respect to the central value RVcen. For example, if the number n is equal to “5”. When first gamma reference values RV1˜RV5 and a central value RVcen are inputted, the second gamma reference values RV1′˜RV5′ are produced by subtracting a corresponding first gamma reference value RV1˜RV5 from double of the central value RVcen. The relationship between the first gamma reference values RV1˜RV5 and the second gamma reference values RV1′˜RV5′ is described as the following equation:

RVn′=2×RVcen−RVn

The above equation is also interpreted by the following equation:

(RVn′+RVn)/2=RVcen

The DAC 412 is electrically coupled to the symmetry unit 411 for outputting first gamma reference voltages V1˜Vn and second gamma reference voltages V1′˜Vn′ in accordance with the first gamma reference values RV1˜RVn and the second gamma reference values RV1′˜RVn′. The DAC 412 is also for outputting voltage Vcom by receiving a value RVcom. Substantially, the central value RVcen is adjustable and may be equal to RVcom. Those skilled in the art should understand that “n” is not limited to be “5”, but also may be any integer number set by the designer.

The video signal is inputted to the line buffer 421. Then, the video signal is inputted to the level shifter 422 and is converted by DAC 423 so as to operate a plurality of data lines of panel 43. For the sake of the gamma correction, the DAC 423 receives the voltages V1˜Vn, V1′˜Vn′ and Vcom. The voltages V1˜Vn, V1′˜Vn′ and Vcom form a gamma curve to adjusted the video signal as being more suitable for human's naked eyes.

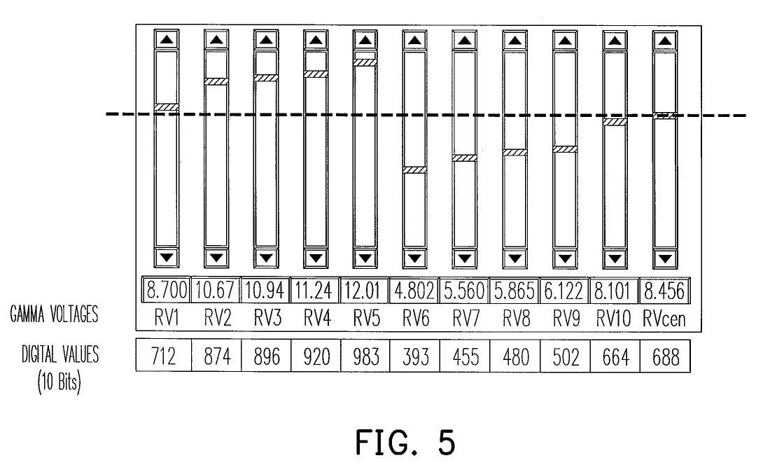

FIG. 5 illustrates a gamma value setting table according to an embodiment of the present invention. When gamma reference values RV1˜RV5 and the central value RVcen are inputted, the corresponding gamma reference values RV6˜RV10 are produced. For example, the 10 Bits digital gamma reference value RV1 is set to “712” and 10 Bits the digital central value RVcen is set to “688”. Then, the digital gamma reference value RV10 is produced by the following equation:

RV10=664=(2*688)−712=(2*RVcen)−RV1

The above equation may be interpreted as the following equation:

(RV1+RV10)/2=RVcen—(664+712)/2=688

Therefore, the other digital gamma reference values are producing as following equations:

RV9=502=(2*688)−874=(2*RVcen)−RV2

RV8=480=(2*688)−896=(2*RVcen)−RV3

RV7=455=(2*688)−920=(2*RVcen)−RV4

RV6=393=(2*688) 983=(2*RVcen)−RV5

Then, the digital gamma voltage values RV1˜RV10 are converted to generate gamma voltages such as 8.700V, 10.67V, 10.94V, 11.24V, 12.01V, 4.802V, 5.560V, 5.865V, 6.122V, 8.101V.

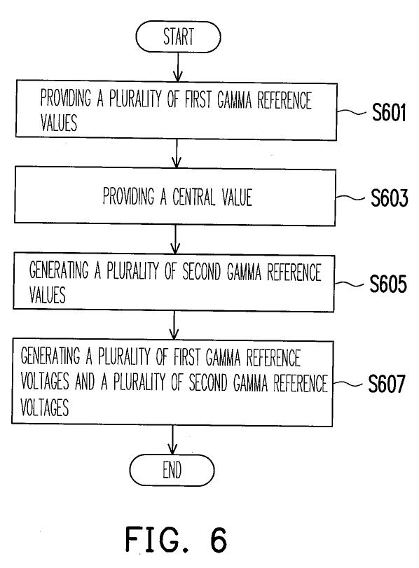

FIG. 6 illustrates a flow of a method for generating gamma voltage according to an embodiment of the present invention. A method: for generating a gamma voltage to a driver of a panel comprises the following steps of: first, in step S601, providing a plurality of first gamma reference values; next, in step S603, providing a central value; in step S605, generating a plurality of second gamma reference values, wherein each of the first gamma reference values and each of the second gamma reference values are symmetrical with respect to the central value; in the step S607, generating a plurality of first gamma reference voltages and a plurality of second gamma reference voltages in accordance with the first gamma reference values and the second gamma reference values.

Though the present invention has been disclosed above by the preferred embodiments, they are not intended to limit the invention. Anybody skilled in the art can make some modifications and variations without departing from the spirit and scope of the invention. Therefore, the protecting range of the invention falls in the appended claims.

What is claimed is:

1. A method for generating a gamma voltage to a driver of a panel comprising the following steps of:
providing a plurality of first gamma reference values;
providing a central value;
generating a plurality of second gamma reference values, wherein each of the first gamma reference values and each of the second gamma reference values are symmetrical with respect to the central value; and
generating a plurality of first gamma reference voltages and a plurality of second gamma reference voltages in accordance with the first gamma reference values and the second gamma reference values.

2. The method as claimed in claim 1, wherein each of the second gamma reference values is produced by subtracting a corresponding first gamma reference value from double of the central value.

3. A gamma voltage generator for a panel, comprising:
a symmetry unit, for receiving a plurality of first gamma reference values and a central value to generate a plurality of second gamma reference values, wherein each of the first gamma reference values and each of the second gamma reference values are symmetrical with respect to the central value; and
a digital-to-analog converter (DAC), electrically coupled to the symmetry unit for outputting a plurality of first gamma reference voltages and a plurality of second gamma reference voltages in accordance with the first gamma reference values and the second gamma reference values.

4. The gamma voltage generator as claimed in claim 3, wherein each of the second gamma reference values is produced by subtracting a corresponding first gamma reference value from double of the central value.

5. The gamma voltage generator as claimed in claim 3, wherein the panel is an LCOS (liquid crystal on silicon) panel.

6. The gamma voltage generator as claimed in claim 3, wherein the panel is an LCD (liquid crystal display) panel.
